(19) United States
(12) Patent Application Publication
(10) Pub. No.: US 2025/0368442 A1
(43) Pub. Date: Dec. 4, 2025

(54) MAIN MODULE, SUB-MODULE, HANDLING SYSTEM AND METHOD FOR HANDLING PHARMACEUTICAL PRODUCTS

(71) Applicant: Körber Pharma Packaging AG, Grabs (CH)

(72) Inventor: Norbert Schlegel, Grabs (CH)

(21) Appl. No.: 19/223,324

(22) Filed: May 30, 2025

(30) Foreign Application Priority Data
May 31, 2024 (DE) 10 2024 115 250.8

(51) Int. Cl. B65G 1/137; B65B 5/10

(52) U.S. Cl. CPC B65G 1/137; B65B 5/103; B65G 2201/027

(57) ABSTRACT

A main module, sub-module and a handling system are provided. The main module has an interface of a main module for connecting a sub-module to the main module, wherein the sub-module and the main module in a connection position are configured to handle pharmaceutical products, including: at least one transfer contact for providing communication between the main module and the sub-module when the sub-module and the main module are in the connection position, at least one first positioning element configured to cooperate with a second positioning element of the sub-module to guide the sub-module and the main module into the connection position. Furthermore, an interface of a sub-module is provided for connecting the sub-module to a main module. Furthermore, a method for handling pharmaceutical products is provided.

### BACKGROUND OF THE INVENTION

The present disclosure relates to a main module for handling pharmaceutical products, a sub-module for connection to a main module for handling pharmaceutical products, a handling system for handling pharmaceutical products and a method for handling pharmaceutical products.

When handling (such as manufacturing, transporting, packaging or similar) pharmaceutical products, it is common for small batch sizes to be handled manually (i.e. manually by an operator). The disadvantage of this is that it increases costs considerably. Furthermore, manual handling can lead to errors, which can have critical consequences, particularly in the case of patient-specific pharmaceutical products.

However, automating this handling is often not cost-effective if only a small number of pharmaceutical products are to be handled. Furthermore, it is costly to adapt automatic devices to individual requirements. In addition, the problem arises that, under time pressure, the required machines have long delivery times, so that they are often not available in time for the production of a small series.

Therefore, the object of the present disclosure is to provide a device and method that can provide improvements in the handling of small batches of pharmaceutical products.

### SUMMARY OF THE INVENTION

According to an aspect of the present disclosure, an interface of a main module for connecting a sub-module to the main module is provided. The sub-module and the main module may be designed in a connection position to handle pharmaceutical products. The interface may comprise at least one transition contact for providing communication between the main module and the sub-module when the sub-module and the main module are in the connection position. Further, the interface may comprise at least a first positioning element adapted to cooperate with a second positioning element of the sub-module to guide the sub-module and the main module into the connection position.

Compared to the known prior art, the interface of the main module has the advantage that a machine for handling pharmaceutical products can be divided into a main module and a sub-module. This provides the advantage that various combinations of main module and sub-modules are possible via the interface. As a result, a machine for handling small batches of pharmaceutical products can be assembled individually, as main modules and sub-modules can be connected to each other as required via the interface. For example, a packaging machine for packaging pharmaceutical products can be assembled flexibly and easily by connecting the required sub-modules to a main module via the interface. This makes it possible to provide automated handling even for smaller batch sizes. Furthermore, switching between different formats of pharmaceutical products can be carried out quickly and economically. The interface can be the only interface between the sub-module and the main module via which information and/or resources are exchanged. This means that a connection between the sub-module and the main module can be designed particularly simply.

The interface can be a contact area between the main module and the sub-module. In the present case, connecting may mean that the main module and the sub-module are brought together so that both modules are in an operative connection. In other words, the main module and the sub-module, when connected (i.e. in the connection position), can interact in such a way that handling of pharmaceutical products is possible. In other words, the main module and the sub-module in the connection position can provide handling of pharmaceutical products that a module could not provide individually. The pharmaceutical product may be a product with special requirements in terms of handling, hygiene, environmental conditions and handling accuracy. In other words, the pharmaceutical product may be a patient-specific product manufactured specifically for a patient. Therefore, extreme care must be taken when handling these products. For example, the pharmaceutical products must not be mixed up. Furthermore, damage to the pharmaceutical products must be avoided, which is why handling them is particularly complex. The pharmaceutical product can be an ampoule, a syringe, a pen, a carpule or the like. The pharmaceutical products can be provided in containers intended for this purpose. For example, the pharmaceutical products can be provided in so-called tubs with nests. The tubs can be tub-like containers in which nests are placed. The nests can transport the pharmaceutical products hanging or lying down. The transfer contact of the interface can be a contact that can interact with an interface of the sub-module using the lock-and-key principle. In the connection position, information, energy and/or other media (e.g. operating resources) can be exchanged via the transfer contact. The advantage of this is that, for example, only the main module needs to have a controller and the sub-module can be controlled via the transfer contact. Furthermore, required media (such as a vacuum) can only be produced or provided in one module and made available to a module connected thereto. This allows the sub-modules to be designed more simply. For example, a vacuum can only be generated in the main module and made available to the sub-module via the transfer contact. This can increase the overall efficiency of the system. The positioning element can be provided as an option. The positioning element can ensure that the transfer contact is connected correctly during contacting. In other words, the positioning element can prevent the transfer contact from being approached at an angle, for example, which would risk damaging the transfer contact. In other words, the positioning element can ensure that two interfaces are brought together in a straight line. Furthermore, the positioning element can ensure sufficient contact pressure between two interfaces. This can ensure that leakage is minimized, particularly when transferring media. By providing the interface of a main module, it can therefore be achieved that sub-modules can be connected to the main module and the interface can be used to form a cooperating unit consisting of the main module and the sub-module. When we talk about the interface in this case, we mean the interface between the main module and the sub-module. The main module has an interface that is complementary to the interface of the sub-module.

Optionally, the first positioning element is designed to fix the sub-module and the main module in the connection position. In other words, the main module and the sub-module can be connected to each other by the first positioning element in such a way that unintentional loosening between the modules is avoided. This means that accidental loosening during operation of the modules can be avoided.

Furthermore, the first positioning element can be designed to guide the main module and the sub-module into the connection position. In other words, when the main module and the sub-module move towards each other, it can be ensured that the sub-module is moved towards the main module in a desired path. This can ensure that the transfer contacts are correctly connected to complementary contacts. Furthermore, additional units of the sub-module can be correctly contacted with units of the main module. This can prevent damage that could be caused, for example, by the sub-module approaching the main module too quickly or incorrectly.

Optionally, the transfer contact is designed to transfer data, a vacuum, a safety signal and/or a supply voltage between the main module and the sub-module. In other words, the main module can fully supply the sub-module with power. This means that the sub-module does not need its own power connection. This makes the connection between the main module and the sub-module particularly simple. Furthermore, it is not necessary for the sub-module to provide its own equipment to generate media such as vacuum, coolant or similar. Instead, this can be obtained from the main module via the transfer contact. This allows the sub-module to be designed more simply.

Optionally, the transfer contact comprises a first sub-contact for a power supply. The power supply can include 24V direct current forwarding. The first sub-contact can comprise two pins for this purpose. The transfer contact can comprise a high-voltage power supply. The high-voltage power supply can provide a voltage of 400V. Three plus one pin can be provided for this. A reserve of two pins can also be provided. A second sub-contact can provide a main supply of vacuum for a transfer of safety air, continuous air. The transfer contact can have a third sub-contact for a protective circuit/earthing. This can ensure potential equalization. This allows the sub-module to be designed simply, as all functionalities are provided via the transfer contact of the interface. The transfer contact can have a fourth sub-contact. The fourth sub-contact can have an internet connection. This allows the sub-module to be accessed by a higher-level control. In particular, the internet connection can be an OPC-UA connection. The internet connection is optionally a GBIT connection. The transfer contact can include a fifth sub-contact for a dummy cover, placeholder for later retrofitting of electronic identification. The fifth sub-contact can, for example, be designed to be connected to a Harting and/or ID-CAN module. The transfer contact can have a sixth sub-contact for an emergency stop. The sixth sub-contact can provide an emergency stop with four pins. Furthermore, the sixth sub-contact may comprise a protective cover with four pins. An emergency stop NTX can comprise four pins. Detection of the dummy cover can be provided with four pins. Furthermore, a reserve with nine pins can be provided in a sixth sub-contact.

Optionally, the first positioning element has a recess into which the second positioning element of the sub-module can be inserted in a contact direction. The recess can be a recess that extends in the contact direction. The recess can be a deepening in the interface.

Optionally, the recess has a funnel-like shape. In other words, the recess can have a larger cross-section on one entry side than on its base area. This allows a second positioning element of a sub-module to be guided into a correct orientation by the funnel-like shape of the recess, even if it is not 100% accurately fed and/or aligned with the main module. This can ensure reliable contact of the interface.

Optionally, a retaining element is arranged in the recess, which can be at least partially gripped from two sides. The retaining element can limit the movement of the sub-module in the contact direction. In other words, the second positioning element of a sub-module can interact with the retaining element in such a way that movement of the sub-module in the contact direction is stopped by the retaining element. As a result, excessive pressure between the interfaces can be avoided. Consequently, the durability of the interfaces can be increased.

Optionally, the first positioning element has a locking mechanism that can be moved between a first position and a second position. The first position can be a release position in which the second positioning element of the sub-module can be removed from the first positioning element. The second position can be a locking position in which the second positioning element cannot be easily removed from the first positioning element. This allows the sub-module to be held on the main module.

Optionally, the locking mechanism can be displaced in a direction transverse to the contact direction. In other words, the locking mechanism can be displaced in a direction that is essentially orthogonal to the contact direction. This can reliably prevent the sub-module from being unintentionally removed from the main module. The angle of essentially 90° to the contact direction can provide the greatest possible holding force. Optionally, the sub-module can only contact or be removed from the main module in the contact direction. The locking mechanism can be displaced in the first direction in order to form a force-fit connection with a complementary element.

Optionally, in the second position, the locking mechanism extends through the recess to cooperate with the second positioning element of the sub-module. In other words, the locking mechanism can be a pin-like element that extends through the recess of the first positioning element. The second positioning element of the sub-module can, for example, have a through-hole through which the locking mechanism passes. This is a simple way of ensuring that the sub-module is held securely on the main module.

According to a further aspect of the present disclosure, an interface of a sub-module for connecting the sub-module to a main module is provided. In a connection position, the sub-module and the main module are designed to handle pharmaceutical products. The interface of the sub-module may comprise at least one transfer contact for providing communication between the main module and the sub-module when the sub-module and the main module are in the connection position. The interface of the sub-module may comprise at least a second positioning element designed to cooperate with a first positioning element of the main module to guide the sub-module and the main module into the connection position.

The interface of the sub-module can be designed to interact with the interface of the main module in order to establish a contact between the main module and the sub-module. Therefore, the interface of the main module and the interface of the sub-module can be referred to as a plug and socket. In other words, the interface of the main module and the interface of the sub-module are related and interact with each other. Similarly, the main module per se and the sub-module per se also have a cooperative relationship, as they can work together to handle pharmaceutical products.

The second positioning element of the sub-module can, for example, be a complementary positioning element to the first positioning element of the main module. In other words, the second positioning element may be a male positioning element, whereas the first positioning element of the main module may be a female positioning element. Therefore, the embodiments and advantages mentioned in connection with the interface of the main module also apply analogously to the interface of the sub-module and vice versa.

Optionally, the second positioning element has at least one projection that is designed to interact with the recess of the first positioning element in a contact direction. The projection can extend in the contact direction. The projection can extend away from a plane on which the transfer contact is arranged. The projection can be used to achieve relative positioning between the sub-module and the main module before the transfer contacts of the main module and the sub-module touch each other. This can ensure optimum guidance of the sub-module relative to the main module so that damage to the transfer contact is avoided.

Optionally, the second positioning element has at least one recess in the at least one projection, which can interact with a retaining element of the first positioning element. In other words, the projection can have a recess. The recess can be open in the contact direction. As a result, the recess can accommodate another element of the first positioning element of the main module. Optionally, the recess does not extend to the original plane of the projection. This means that the recess can be used as a movement limiter in the contact direction, for example, by inserting a complementary element of the first positioning element of the main module into the recess. This allows a contact position to be defined between the main module and sub-module.

Optionally, the second positioning element has a through-hole into which a locking mechanism of the first positioning element can at least partially enter. This allows the sub-module and the main module to be fixed relative to each other. By providing the through-hole in the projection, it is not necessary for the first positioning element to provide a complicated hook-and-eye system. This makes it possible to provide a particularly simple system for fixing a relative position between the sub-module and the main module.

Optionally, the through-hole extends transversely to the contact direction. This can provide a particularly stable connection between the sub-module and main module, especially if the sub-module can only be removed from the main module in the contact direction.

Optionally, the projection has a thickening at its origin. In other words, the projection can have a shape that tapers towards its outer end. This can provide optimum guidance of the sub-module relative to the main module when both modules are moved towards each other. For example, alignment between the main module and sub-module can only be rough, so that the second positioning element comes into contact with the first positioning element. By moving the sub-module further in the contact direction, a relative orientation between the sub-module and the main module can be adjusted through the interaction of the first positioning element and the second positioning element. Due to the tapered shape of the projection, the tolerances can continue to decrease the further the sub-module is moved towards the main module in the contact direction. This can simplify the handling of the sub-module. The thickening can also serve as a friction contact between the main module and sub-module, for example, in order to reduce the speed of movement in the contact direction. This can prevent damage to the interface.

Optionally, the projection has at least one sliding element. The sliding element can be designed to minimize friction between the first positioning element and the second positioning element. The sliding element can provide a particularly smooth surface (in particular smoother than a surface of the remaining sub-module). This can make it easier to bring the main module and the sub-module together. Furthermore, wear can be minimized by reducing the friction of the first positioning element sliding along the second positioning element. Furthermore, less force is required to adjust the relative orientation between the sub-module and the main module.

Optionally, the projection has two sliding elements that are arranged one behind the other in the contact direction. This can ensure that one sliding element also comes into contact with the complementary positioning element.

Optionally, the at least one sliding element is designed as a roller whose axis of rotation is essentially orthogonal to the contact direction. For example, a roller can be provided at the outer end of the projection. This area will first come into contact with the positioning element of the main module. By arranging a roller in this area, the second positioning element can thus slide into the first positioning element of the main module, without causing increased friction. This makes it easier to position the sub-module relative to the main module.

According to a further aspect of the present disclosure, a main module for handling pharmaceutical products is provided. The main module may comprise at least one interface having the features of any of the above embodiments. The main module may comprise a handling device designed to handle pharmaceutical products in a handling area. The main module may comprise a control unit designed to control the handling device. The main module may comprise a conveyor device designed to convey pharmaceutical products in a conveying direction.

The main module can accommodate various sub-modules via the at least one interface. This means that the main module can be used as a central handling device, wherein at least one sub-module (also known as a supply unit) can be docked onto the main module. The main module can also have a plurality of interfaces to which similar or different sub-modules can be docked. This allows the main module to be designed as a central module. In the case where the main module has a plurality of interfaces, each interface can be designed in the same way. This can increase variability and sub-modules can be flexibly connected to the main module. The handling device cannot be a device designed to physically displace pharmaceutical products. Furthermore, the handling device can be designed to manipulate medical products or packaging material for medical products. For example, the handling device can open, close and/or displace a package. This allows the packaging to be brought into a desired position for subsequent handling. The handling area can be the area in which the handling device can be active. In other words, the handling area can be the area where the handling device can reach pharmaceutical products. Optionally, the handling area is defined circularly around an origin of the handling device. The control unit can be a computer-like device that is designed to receive data (input data), evaluate the data and output data (output data). The output data can be control commands that can, for example, control the handling device. The control unit can, for example, feed control commands to a sub-module via the interface. Furthermore, the control unit can obtain sensor information via the interface from at least one connected sub-module. This allows the control unit to provide centralized control of several sub-modules connected to the main module. In other words, it is not necessary for each sub-module to have its own control unit. Furthermore, a central control unit can prevent contradictory or counterproductive control commands from being generated. Furthermore, the main module can have a measuring device that is designed to determine a position of at least one sub-module relative to the main module. The relative position of the sub-module to the main module can then be used to control the handling device. This is advantageous if, for example, a predefined position of the sub-module relative to the main module cannot be guaranteed. Since only the main module has a handling device (and not the sub-module), it is important to consider a variable relative position of the modules. This ensures error-free handling of the medical products. For example, the sub-module may be inclined relative to the main module and/or not be connected straight to the main module. The measuring device can recognize this and generate position information (distance and/or angle). This position information can be recorded by the measuring device and taken into account when controlling the handling device. More precisely, the handling device can be calibrated based on the position information. The measuring device, which can be arranged on a frame of the module, can measure a distance between the main module and the sub-module. If the sub-module is standing on a flat surface, the measuring device measures 85 mm, for example. If the surface is inclined, then the measuring device can measure a shorter distance. For example, if the measuring device measured a distance of 83 mm, the sub-module would be inclined by 0.173° relative to the main module (e.g. sloping downwards to the horizontal plane). This deviation can be transferred to the handling device via software, e.g. to achieve a correct pick position (i.e. handling). The conveyor device can, for example, convey pharmaceutical products or packaging in one conveying direction. The conveyor device can enter the main module on an upstream side and exit the main module on a downstream side. For example, each time a sub-module (supply unit) is connected to the main module, calibration information (e.g. position information) can be transferred to the control unit (e.g. a product handling unit), as the sub-modules may be different. The calibration information can be communicated via the interface between the main module and the sub-module. The calibration information can include product information and/or function information. Furthermore, the calibration information can additionally or alternatively be read out via QR/bar code or the main module has sub-module recognition (optical with camera, scanner, digital transmission with identifier via data bus, etc.). The calibration information (e.g. product information and/or function information) can be automatically transferred from the docked sub-module to the main module and thus to the handling device. In this way, the control (e.g. by means of control parameters) of the handling device and the data transferred to the sub-module (e.g. to its data) can be adapted. This means that the sub-modules can be changed and the main module can still provide customized handling for each connected sub-module.

Optionally, the main module can have a single handling device (i.e. only one handling device), which is preferably set up to operate several sub-modules in their handling area. This can simplify control, as several handling devices do not have to be controlled in parallel. The interface between the main module and sub-module can provide a defined contact (e.g. via the positioning element). However, this contact may be the only point of contact between the main module and the sub-module (i.e. the only point of contact). Therefore, the sub-module can theoretically have a different orientation to the main module, at least in sections (e.g. further away from or closer to the main module at the lower part). This can lead to inaccuracy when handling products with the handling device. More specifically, a pick operation by the handling device may fail because a relative positioning between the main module and sub-module is not within an expected range. This problem can be countered by the measuring device so that the control of the handling device can take into account a relative alignment of the main module and the sub-modules to each other. Alternatively, care can be taken to ensure that the main module and the sub-module are always aligned with each other in the same way.

Optionally, the conveyor device extends through the handling area. In other words, the product transported on the conveyor device can be handled by the handling device. Products can thus be made available to the main module via the conveyor device and via at least one connected sub-module. The main module can then handle the products by means of the handling device and, if necessary, bring them together.

Optionally, the main module has at least one docking area with the interface, wherein the docking area and the handling area at least partially overlap. The docking area can be an area of the main module to which a sub-module can be connected. The interface, which can establish an active connection with the sub-module, is optionally arranged in the docking area. At least part of the sub-module can be arranged in the docking area. As a result, the handling device of the main module can comprise an active area that also at least partially comprises the sub-module. This allows the main module to serve as a kind of distribution unit for handling the product provided by the at least one sub-module. For example, if two or more sub-modules are connected to the main module, the handling device of the main module can provide a product from one sub-module to another sub-module. This is advantageous, for example, if one sub-module is a feed module that feeds pharmaceutical products and the other sub-module is a module that labels pharmaceutical products. In this case, the handling device can feed the pharmaceutical product from the feeder sub-module to the label sub-module and then feed it to a package provided on the conveyor device of the main module. Furthermore, the handling device of the main module can also handle other products that are provided by other sub-modules. For example, it is conceivable that a package insert or the like is fed to a package of the pharmaceutical product. Such a package insert can, for example, be provided by a separate sub-module, which can be connected to the main module.

Optionally, the handling device is a six-axis robot. In other words, the handling device can be a robot arm. The handling device may have six degrees of freedom. Alternatively, a SCARA robot may be provided as the handling device. A SCARA robot may comprise four axes and thus four degrees of freedom. The axes of the handling device can be designed as serial kinematics. In other words, the coordinate origin of a subsequent axis can only be dependent on a position of the previous axis. This can ensure that the handling device can reach and handle all products in the handling area.

The conveyor device is optionally designed as a conveyor belt. This can be used, for example, to transport packaging for pharmaceutical products into the handling area of the handling device.

Optionally, the control unit is designed to additionally control at least one sub-module docked to the interface. As already indicated above, the control unit can receive and send information from the sub-module via the interface. This means that the control unit of the main module can be used as the central control unit for a combined system of main module and sub-module.

Optionally, the handling device is arranged above the conveyor device in the gravity direction. This can ensure that the handling device has a sufficiently large handling area and can also satisfactorily reach sub-modules docked to the main module. It also allows the space in the main module to be used efficiently.

The handling device is optionally arranged centrally in the main module. This means that each sub-module, which is arranged on the main module, can be reached easily. Optionally, the main module is rectangular in plan view. The transport device can enter and exit the main module on two opposite sides. A docking area can be provided on the two other opposite sides, to which sub-modules can be connected. If the opposite sides are connected with orthogonal lines that originate centrally on each side, the handling device can be arranged at an intersection of these connecting lines. This can ensure that the handling device reaches every area in the handling area satisfactorily.

Optionally, the handling device has an end effector connection designed to connect a plurality of different end effectors. An end effector can be designated as an element of a kinematic chain of a handling device. The end effector can be, for example, a gripping device or another device for manipulating other objects. The end effector connection can therefore provide variability of the handling device so that different activities can be realized with one handling device. In the embodiment, an end effector can be a suction gripper or a mechanical gripper, for example. Furthermore, differently designed suction grippers can be connected to the handling device. As a result, a wide range of products and/or packages can be handled by the handling device.

Optionally, the main module comprises a sensor system designed to monitor the handling area. The sensor system can be used, for example, to check whether handling was successful. Furthermore, prepared products can be identified and a control of the handling device can be adapted based on this. Furthermore, a position in the handling area can be identified by the sensor system and the handling device can be controlled accordingly. This means that short-term adjustments or changes to the process sequence are also possible without having to make major adjustments.

Optionally, the sensor system comprises a camera. In other words, the output of the sensor system can comprise images. These images can be classified by the control unit, for example, in order to identify a product type. In other words, the control unit can store a control system that is different for each product type (e.g. vials, syringes, pens and the like). Using the image data, the control unit can identify which product type is to be handled by the handling device. Furthermore, the control unit can also classify errors or inaccuracies based on images. For example, the control unit can know how a label should be applied to a pharmaceutical product. If the camera system detects a label attached to a pharmaceutical product that does not meet this requirement, a corresponding signal can be issued. It is also conceivable that the handling device directly removes such a faulty product.

The sensor system is optionally designed to be spatially displaceable. In other words, the sensor system can be relocated in the main module. This can ensure, depending on the specific task being performed, that the sensor system provides the sensor data required to control the overall system. This can, for example, avoid a sensor shadow in which relevant information has to be recorded.

Optionally, the main module comprises a programming interface. A programming interface can, for example, be a wired or wireless contact point. This makes it easy to influence the programming of the main module or the control unit of the main module in order to make short-term adjustments.

Optionally, the programming interface can be extended and retracted from the main module like a drawer. This prevents soiling or damage to the programming interface, particularly in the case of wired contacts. For example, the programming interface can be pulled out of the main module like a drawer and then opened up to be connected to a programming device. Once the work is complete, the programming interface can be easily pushed back into the main module, where it is protected from contamination and damage.

Optionally, the handling area is surrounded by a protective device to prevent unwanted access. The protective device can be made of glass elements, for example. This can prevent other equipment or people from reaching into the active area of the handling device but still being able to see what is going on. Furthermore, the protective devices can also ensure that a certain atmosphere is maintained in the handling area. For example, it may be necessary for a certain temperature and/or pressure to prevail in the handling area.

Optionally, the main module comprises at least one dummy cover that can be arranged in the at least one docking area in order to close it. This is useful, for example, if not all docking areas of a main module are occupied by sub-modules. In this case, one docking area is exposed. In particular, the interface of the main module is exposed. On the one hand, this can lead to soiling of the interface. Furthermore, such an exposed docking area can also represent a gap in the protective device surrounding the handling area. It is therefore advantageous to provide a blind cover that covers the interface on the one hand and fills the gap in the protective device on the other. For example, it is conceivable that a case-like dummy cover is provided that interacts with the interface of the main module. Furthermore, the dummy cover can comprise a detachable protective device so that the entire protective device that provides the handling areas is supplemented. Optionally, the dummy cover can have an interface complementary to the interface of the main module. This can be used to signal to the control unit of the main module that this interface, to which the dummy cover is provided, is not in operation and that no sub-module is connected there. This can be used as the basis for controlling the handling device. This can prevent the handling device from colliding with the dummy cover or a partial protective device of the dummy cover.

The case-like design of the dummy cover can ensure easy handling. For example, a handle can be provided that can be easily gripped by an operator in order to install or remove the dummy cover.

Optionally, the main module comprises a sub-module sensor system, which is designed to detect a position of a sub-module in the docking area relative to the position of the main module and to output position information. The sub-module sensor system can also be referred to as a measuring device (see above). Due to uneven hall floors, a combination of a sub-module and a main module can lead to tilting relative to each other. This in turn can lead to faults in the mechanical interaction between the main module and the sub-module. The sub-module sensor system can be used, for example, to determine a distance between the main module and the sub-module. Furthermore, an inclination sensor can be provided that can determine a tilt. For this purpose, the sub-module can, for example, have a counter plate at a specific point, which can be used to measure a distance between the main module and sub-module. Such a distance can be provided, for example, by an optical sensor (e.g. time of light sensor) or a capacitive sensor that capacitively determines a distance between the distance sensor and a counter plate. Other sensor types are also conceivable. Several sensors can also be provided in order to achieve an even more accurate result. Furthermore, the sub-module sensor system can be designed to determine an angle directly or indirectly. Directly can mean that the sub-module sensor system can measure the angle between the main module and sub-module. Indirectly can mean that the sub-module sensor system measures a distance and determines an angle from this.

Optionally, the control unit is designed to control the handling device based on the position information. This allows the handling device to be operated accordingly in the event of a tilt between the sub-module and the main module in order to ensure smooth interaction between the main module and the sub-module.

Optionally, the sub-module sensor system comprises at least one inclination sensor.

Optionally, the handling device is designed to open and/or close a package for pharmaceutical products. In this way, a package for pharmaceutical products fed to the main module can first be opened by the handling device, then loaded with a pharmaceutical product by the handling device and then closed again by the handling device. This means that the main module can be used for a variety of activities, even if not all of these activities necessarily have to be carried out by the main module.

According to a further aspect of the present disclosure, a sub-module for connection to a main module for handling pharmaceutical products is provided. The sub-module may comprise an interface having the features of any of the above embodiments. The sub-module may comprise an input area designed to receive pharmaceutical products. The sub-module may comprise a handling area designed to handle the pharmaceutical products. The sub-module may comprise an output area designed to provide the pharmaceutical products. The output area can be arranged in a docking area of the main module.

In principle, the sub-module can fulfill two basic tasks. Firstly, the sub-module can be designed as a feed module. The feed module can feed products that are to be handled to the main module. These can be pharmaceutical products, but also information carriers or other objects that are used in conjunction with pharmaceutical products. Furthermore, the sub-module can be provided as a service module. A service module can process pharmaceutical products handled by the main module. For example, a service module can be designed as a label printer. Furthermore, the service module can also be designed as a control module. It is also conceivable that the service module could be designed as an ejection container for bad products, a laser station, an assembly device or a lateral feeding device for products that are to be inserted laterally into a package or as a feeder for booklets or the like. The input area can be an area at a distance from the main module. Pharmaceutical products, for example, can be inserted into the input area. The input can be manual or automated by another machine. Furthermore, the input area can also be arranged facing the main module. In this case, the sub-module can receive pharmaceutical products from the main module. This is advantageous, for example, if the sub-module performs a process step with the pharmaceutical products. The handling area of the sub-module can either be the area where a process is carried out with the pharmaceutical product or where the pharmaceutical product is transported in a certain way. The output area can be the area where the sub-module delivers the pharmaceutical product. Optionally, the output area faces the main module so that the handling device of the main module can take over the pharmaceutical product from the sub-module. In the case of a sub-module as a service module, the output area can be the same as the input area. In the case of a sub-module that serves as a feeding module, the input area and the output area can be provided at different locations. The output area can be the area from which the handling device of the main module removes the pharmaceutical products. Therefore, it is advantageous if the output area is located in the handling area (i.e. in the docking area) of the main module. In particular, the sub-module may not have a handling device comparable to the handling device of the main module. Thus, the medical products can be handled centrally by a handling device of the main module. Consequently, the sub-module can have a simpler design, which provides cost benefits and tax advantages. In addition or as an alternative to the main module, the sub-module may have a measuring device designed to determine a relative position between the sub-module and the main module. The measuring device can be designed identically to the measuring device of the main module (see above).

Optionally, the sub-module can be controlled by a control unit of the main module via the interface. In other words, the sub-module cannot have its own control unit. Instead, it can receive control commands from the control unit of the main module. This makes it possible to avoid duplicate control or contradictory control. Furthermore, centralized control of the main module can be used. This can ensure an efficient process flow.

Optionally, the sub-module has an end effector holder for holding at least one end effector for the handling device of the main module. In other words, the sub-module can have different end effectors in order to equip the handling device of the main module with at least one end effector. This offers the advantage that each sub-module directly supplies the end effector required for the respective sub-module. As a result, the main module does not need a holder for end effectors. Optionally, the main module has no storage device or holder for end effectors. Instead, the handling device of the main module can remove the required end effectors from the sub-module. This means that it is not necessary to provide end effectors, as these are automatically made available to the handling device when a sub-module is connected to the main module. This simplifies the individual combination of main module and sub-module.

Optionally, the holder is arranged in the output area of the sub-module. The fact that the output area is located in the handling area of the handling device of the main module when the sub-module is connected to the main module can ensure that the handling device reaches the holding for end effectors.

Optionally, the sub-module has a denester to provide a nest in the output area. Pharmaceutical products are usually transported in a tub holding a nest. In order to be able to handle the pharmaceutical products easily, it is necessary to remove the nest from the tub. Because the sub-module has a DE nest, the nest with pharmaceutical products can be removed from the tub and placed in the output area so that the handling device of the main module can easily handle the pharmaceutical products.

Optionally, the output area is designed to hold the nest in place. The pharmaceutical products can, for example, be held in the nest by a snap-loss closure. This means that a certain amount of force is required to discharge the pharmaceutical products from the nest. Because the output area is designed to fix (i.e. hold) the nest, the handling device of the main module can apply the necessary force to remove the pharmaceutical product from the nest.

Optionally, the output area is designed to at least partially release pharmaceutical products from a holder in the nest. In other words, in addition to the force that the handling device of the main module exerts on the pharmaceutical products to release them from the nest, the output area can also act to release the pharmaceutical products from the nest. Here it is conceivable that a mechanical support acts to release the pharmaceutical products from a holder in the nest.

Optionally, the output area is designed to release pharmaceutical products from a holder in the nest by lifting the pharmaceutical products against the gravity direction. Pharmaceutical products are optionally transported hanging in nests. To prevent the pharmaceutical products from falling out of the nest unintentionally, a clip mechanism is often provided to secure the pharmaceutical products in the nest. The output area can overcome such a clip mechanism by physically acting on the pharmaceutical products so that the handling device of the main module can easily remove the pharmaceutical products. The gravity direction can be the direction of gravity.

Optionally, the output area has a first output area section and a second output area section. In other words, the output area can be divided into two parts. This allows a tub from which a nest has been removed to be temporarily stored in the output area while the nest is being unloaded by the handling device.

Optionally, the first output area section and the second output area section can be arranged next to each other in the docking area of the main module. This allows both output area sections to be arranged in the handling area of the handling device. Consequently, both sections can be reached by the handling device.

Optionally, the first output area section is designed to receive and/or hold a nest by means of a nest holding device. Optionally, the nest is held by the first output area section on a collar of the nest. As a result, pharmaceutical products that are held hanging in the nest can be picked up easily. Thus, a nest can also be provided in the first output area without a tub. Furthermore, the first output area section can be designed to hold the nest. In other words, a force can be exerted on the nest to prevent the nest from displacing. Holding the nest can be realized either mechanically or pneumatically.

Optionally, the nest holding device is designed to hold the nest by means of negative pressure or vacuum. This means that suction openings can be provided in the area that carries the nest, to which negative pressure is applied. This allows the nest to be sucked onto the first output area section in order to hold the nest. This allows the handling device of the main module to remove pharmaceutical products from the nest, which are held by the nest, without displacing the nest.

Optionally, the nest holding device has a release device which is designed to release a pharmaceutical product at least partially from the nest. As already indicated above, pharmaceutical products can be held in the nest by a mechanism of the nest. In order to release these pharmaceutical products from the nest, a certain force is required to overcome the holding force. The release device can exert a proportional force on a pharmaceutical product so that it can be released from the nest more easily. This means that the handling device does not have to exert the force required to overcome the holding force on its own. As a result, the handling device of the main module can be designed more simply.

Optionally, the release device comprises a cross table and/or at least one plunger. The cross table can be movable under the nest (i.e. in the gravity direction) so that pharmaceutical products can be reached at any point of the nest. The plunger can be a mechanical device that contacts a pharmaceutical product in the gravity direction from below. By applying a force, the pharmaceutical product can be pushed out of the nest. This allows it to be easily gripped by the handling device of the main module.

Optionally, the first output area section is designed to transport a tub with a nest using a first conveyor device. In other words, the first output area section can transport a tub, in which a nest with pharmaceutical products is accommodated, into the docking area. The first output area section can take over the tub from a handling area of the sub-module.

The first conveyor device is optionally designed to be foldable. This means that the first conveyor device can be folded away to reveal an element underneath. This allows the space in the docking area to be optimally utilized.

Optionally, the nest holding device is arranged under the first conveyor device in the gravity direction. In other words, when the conveyor device is folded away, the nest holding device can be accessible. For example, it is conceivable that a tub with a nest on the conveyor device is inserted into the docking area and then transferred to the second output area section by the handling device of the main module. The first conveyor device can then be folded away, making the nest holding device accessible. The handling device can then remove the nest from the tub and feed it to the nest holding device in the first output area section. Further processes can then take place. Optionally, the handling section of the sub-module is designed to feed a tub with a nest containing pharmaceutical products to the first output area section. In other words, the handling section of the sub-module can be located outside the handling area of the handling device of the main module. Thus, the handling section can be operated exclusively by the sub-module itself. The handling section can feed a tub or other pharmaceutical products to the first output area section. The handling section can be designed to feed the pharmaceutical products to the first output area section at a predetermined frequency. To set a desired frequency, the handling section can comprise at least one stopper that can hold back subsequent tubs or other pharmaceutical products until they can be introduced into the first output area section. This allows the pharmaceutical products to be fed to the output area of the sub-module in such a way that they can be handled efficiently.

Optionally, the handling section is designed to transport a tub with a nest out of the second output area section. In one embodiment, tubs with nests are fed back to the handling section of the sub-module after being handled in the output area. For this purpose, the second output area section can transport the tub away and transfer it to the handling section. The handling section can then remove the tub with the empty nest, for example.

Optionally, the second output area section is designed to temporarily store and/or hold a tub by means of a second conveyor device. At one embodiment of the present disclosure, a nest of pharmaceutical products is removed from a tub in the output area section and held in a nest holding device. Thereby, the empty tub may remain in the second output area section until the nest is emptied, whereupon the nest is returned to the tub. In one embodiment, an end effector holder is disposed below the second output area section (further details follow below). In this case, the second output area section may be foldable to reach the end effector holder. Therefore, it may be advantageous if the second output area section can not only temporarily store the tub, but can additionally hold the tub such that the entire second output area section is foldable without the tub falling down.

Optionally, the second output area section is foldable. In other words, the second output area section can be folded down by essentially 90° so that an area under the output area section becomes accessible. This allows the space in the output area to be used even more efficiently.

Optionally, the second output area section has an end effector holder, which is designed to hold at least one end effector for the handling device of the main module. This provides the advantage that a suitable end effector is made available to the main module directly with the sub-module. This means that the function of the sub-module, which is often associated with a specific end effector, can be optimally supplemented by the main module. The end effector holder can be a storage space in which one or more end effectors are arranged so that they can be automatically removed by the handling device of the main module. The end effectors can be arranged next to each other so that they can be picked up one after the other by the handling device.

Optionally, the end effector holder is arranged under the second conveyor device in the gravity direction. This allows the space to be used highly efficiently, as the end effector holder and the second conveyor device are not used simultaneously, it is possible to arrange both elements in such a way that they can be used one after the other.

Optionally, the handling section is designed to provide a pharmaceutical product with a label. In this case, the sub-module can be a service sub-module. In this case, the sub-module can pick up a pharmaceutical product from the handling device of the main module, process it (for example, apply a label) and then make it available again to the main module or the handling device of the main module. The label application action can take place either in the handling area of the handling device or outside the handling area of the handling device of the main module. Depending on the positioning in the sub-module, the handling section of the sub-module can be reached via an output area or alternatively be fed directly by the handling device of the main module.

Optionally, the handling section is designed to check a pharmaceutical product. In this case, the sub-module can be designed to carry out an inspection of the pharmaceutical product. Here, the pharmaceutical product can be inspected for damage. Furthermore, information applied to the pharmaceutical product or packaging can be checked. In addition, a turbidity check or a suspended particle check can be carried out. Depending on which safety or control measures are intended for the respective pharmaceutical product, a control can be provided individually by a corresponding sub-module. The check itself can, for example, be a comparison of the actual situation, which is recorded by sensors for example, with a target state as it should be.

Optionally, the handling section is designed to burn information into the packaging of the pharmaceutical product using a laser. In this case, the sub-module can, for example, burn an engraving into the packaging of the pharmaceutical product using a laser. This is particularly advantageous if the pharmaceutical product is contained in glass containers. This allows information to be applied to the pharmaceutical product in a simple and automated manner, particularly in the case of individualized pharmaceutical products. Optionally, the handling section comprises an assembly device that is designed to add an element, in particular a cover, to the pharmaceutical product. Thus, for example, an assembly can be provided by a sub-module. For example, it may be necessary for the pharmaceutical product to be packaged and/or finally assembled after a final check of the pharmaceutical product. For example, it is conceivable that a cap or cover could be added to the pharmaceutical product.

Optionally, the sub-module has a memory designed to store product information and/or information about the sub-module, wherein the sub-module is designed to output the product information and/or information about the sub-module via the interface. Product information may be indicative of which product (i.e. which medical or pharmaceutical product) is handled by the sub-module. The memory can, for example, be designed as RAM, ROM and/or RFID, in particular as an encoded RFID chip. The information about the sub-module can be indicative of which operation can be carried out by the sub-module (e.g. labeling products, providing products, filling products, etc.). Furthermore, the information about the sub-module can include positional information about where the handling device of the main module can handle what on or in the sub-module. The sub-module can connect to a main module via the interface of the sub-module. Information can be exchanged between the sub-module and main module via communication established in this way. The information can include, for example, sub-module data such as ID, type, etc. The information transmitted by the sub-module can then be made available to the control unit in the main module. The control unit can then use the information to control the handling device.

Optionally, the sub-module is designed to provide an information carrier in the output area. In other words, the sub-module can not only provide pharmaceutical products in the output area, but also package inserts or other information carriers. These can be easily and individually added to the packaging of the pharmaceutical product by the handling device of the main module.

Optionally, the sub-module can be displaced with at least one wheel. The sub-module can be individually docked onto a main module. For this purpose, it is advantageous if the sub-module can be moved in a simple manner. In the present embodiment, this is provided with a wheel system. The sub-module can have at least one wheel. Optionally, the sub-module has four wheels. This means that it can be easily moved by a single person and arranged at any position on a main module.

Optionally, the sub-module has a traction drive to displace the sub-module. With heavier sub-modules, it can be difficult for a single operator to displace the sub-module. For this purpose, the sub-module can have a drive that can drive at least one wheel. This makes it particularly easy to transport the sub-module to a desired position or location. The traction drive of the sub-module can be coupled to the interface, for example, so that the traction drive can only be operated when the interface is enabled. This can prevent unintentional operation of the traction drive, which prevents damage to the interface.

Optionally, the at least one wheel is arranged on a fold-out frame, which is displaced between a driving position and a production position. Since a sub-module often has a greater extension in the gravity direction than in the width or depth direction, there is a risk that the sub-module may tip over when the sub-module is moved. A fold-out frame can be provided for this purpose, which is designed to function as a kind of support wheels. This allows the distance between the individual wheels to be increased, which leads to greater stability of the sub-module during displacement. Optionally, the traction drive can only be driven when the frame is in a driving position. In other words, the sub-module can only be moved when the wheels are folded out (i.e. the driving position is assumed). This prevents sub-modules from falling over during transportation.

Optionally, the control unit of the main module is designed to identify at which interface the sub-module is arranged. In other words, the control unit can automatically recognize where which module is located. Based on this, the control unit can control the handling device of the main module.

Optionally, the control unit of the main module is designed to identify which sub-module is docked. In other words, the control unit can recognize which type of sub-module is attached to the main module. This allows the control unit to know at which point in the docking area of the main module which activity can be performed. This can be used as the basis for controlling the handling device. This can be done remotely using a bar code and/or a QR code.

Optionally, the control unit of the main module is designed to obtain product information about the pharmaceutical product to be handled via the interfaces. In other words, a sub-module can be indicative of which pharmaceutical product it is feeding. This information can be output to the control unit of the main module via the interfaces. In this way, a new handling line can be realized in a simple manner. More precisely, it is not necessary to enter complex information, whereas it is sufficient to connect a corresponding sub-module to a main module so that the main module automatically receives information about the type of pharmaceutical product introduced by the sub-module.

Optionally, the control unit of the main module is designed to obtain functional information of the sub-module via the interfaces. In other words, the sub-module can automatically communicate an information via the interfaces as to which function the sub-module provides. This allows the control unit to adapt the control of the handling device of the main module accordingly. In other words, the handling device of the main module can be controlled based on the information.

Optionally, the handling device is designed to pick up an end effector from a sub-module. In other words, the handling device can be designed to take over an end effector exclusively from a sub-module. This offers the advantage that the sub-module also provides the end effector required for the function provided.

Optionally, the handling device is designed to pick up a pharmaceutical product from a first sub-module and transfer it to a second sub-module. This is advantageous, for example, if a sub-module is designed as a feed module and feeds the pharmaceutical products to the main module. The other sub-module can then be designed as a service module, which provides further processing of the pharmaceutical product. The handling device of the main module can serve as a central distribution element that transfers the pharmaceutical product from one station to the other. It is conceivable that a plurality of further sub-modules are provided, all of which provide a specific functionality. In particular, the sub-module does not have a handling device like the main module.

Optionally, the handling device is designed to handle a tub with a nest in an output area of the sub-module. In other words, the handling device of the main module can support functionalities of a sub-module. For example, the handling device can transfer the tub in an output area from a first output area section to a second output area section. For example, in the case of a two-part output area of a sub-module, the handling device can transfer a tub from the first output area section to the second output area section. Furthermore, denesting (i.e. removal of a nest from a tub) can be realized by the handling device of the main module. In this case, the handling device can remove the nest from the tub and feed it to a nest holder. This means that the functions of the main module and a sub-module can complement each other.

Optionally, the handling device is designed to feed pharmaceutical products from several sub-modules to a package. In one example of the present disclosure, only one pharmaceutical product, which is provided by a sub-module and possibly labeled by a further sub-module, is fed to a package, which is transported on the conveyor device of the main module. However, in a further embodiment, different pharmaceutical products, each provided by a sub-module, can also be fed to a package. This makes it easy to achieve the desired combinations.

According to a further aspect of the present disclosure, there is provided a handling system for handling pharmaceutical products comprising: a main module according to any of the above embodiments and at least one sub-module according to any of the above embodiments. A plurality of sub-modules may be connected to the main module to form the handling system. The main module may comprise the single handling device. In other words, the at least one sub-module connected to the main module may have no handling device. By only providing a handling device (e.g. a robot arm) in the main module, the sub-modules can be designed more simply. The handling device can be designed to handle pharmaceutical products (in particular exclusively pharmaceutical products). In other words, the handling device can meet special hygiene requirements such as sealed joints, sterilizable material, avoidance of open lubrication and the like. This means that particularly high hygiene requirements can be met by the handling system.

Optionally, the main module and/or the at least one sub-module has or have a measuring device which is designed to determine a position of the at least one sub-module relative to the main module. The measuring device can also be designed to output the relative position (e.g. distance and/or angle) between the main module and the at least one sub-module to the control unit. If the measuring device is arranged in the sub-module, the information can be passed on via the interface to the main module in which the control unit is arranged. Based on the relative position, the control unit can control the handling device. In other words, the control unit can be designed to control the handling device based on the information from the measuring device (i.e. the relative position).

According to a further aspect of the present disclosure, a method for handling pharmaceutical products is provided. The method may comprise a transfer of a pharmaceutical product from a sub-module by a handling device of a main module. The method may comprise introducing the pharmaceutical product into a package transported by a conveyor device of the main module.

Optionally, the method comprises docking the sub-module to the main module. Docking may involve physically moving the sub-module into a docking area of the main module. This allows a plurality of different sub-modules to be arranged in a main module.

Optionally, the method includes automatic registration of the sub-module with the main module. The interface can be used to transmit information from the sub-module to a control unit of the main module. For example, information about the type of sub-module can be exchanged. Furthermore, information about the relative orientation and/or positioning of the sub-module relative to the main module can be exchanged. This allows the control of the handling device to be adapted to a combination of main module and sub-module.

Optionally, the method comprises inserting a tub with a nest and pharmaceutical products into the sub-module. In other words, the sub-module may manually or automatically comprise tubs with a nest and pharmaceutical products accommodated therein.

Optionally, the method includes providing the end effector for the handling device of the main module in the sub-module. As a result, depending on the functionality of the sub-module, the handling device of the main module can be designed with a suitable end effector.

Optionally, the method comprises lifting the pharmaceutical products in the nest by the sub-module to enable the handling device to remove the pharmaceutical products.

According to one embodiment of the present disclosure, a sub-module is connected to a main module by an operator. The sub-module automatically registers to the control unit of the main module. During registration, information can be transferred from the sub-module to the main module. In particular, the control unit of the main module can obtain information about the sub-module. The information can include a relative position of the sub-module to the main module. Additionally or alternatively, the information may include characteristics of the sub-module such as type of operation, coordinates, where what is provided and the like. Filled tubs with nests and pharmaceutical products in them then enter the sub-module on an input area. Then the tub-nest gripper (as an example of an end effector) is provided for the handling device of the main module by swinging away a second output area section of the sub-module. The handling device of the main module grips the tub with the tub-nest gripper and moves the filled tub from the first output area section to the second output area section. The sub-module then swivels the first output area section by essentially 90°. The handling device of the main module then picks up the nest from the tub and places it on the nest holding device, which is located under the first output area section. The empty tub is then transported away from the second output area section. Alternatively, the empty tub can remain on the second output area section. The second output area section is then swung away to give the handling device of the main module access to the end effector holder. The handling device of the main module then places the tub-nest gripper in the holder and picks up a product gripper from the holder. At the same time, a sensor system can check the alignment of the individual products in the nest and feed information to the control unit accordingly. The handling device can then pick up the individual products from the nest. Here, the nest holding device can help to overcome a detent by means of a cross slide or other devices in order to be able to pick up the pharmaceutical products from the nest without any problems. The handling device of the main module places the individual products in a holder provided for this purpose in another sub-module (i.e. a sub-module designed as a service module). However, this is only optional. The handling device of the main module can also place the pharmaceutical product directly into a holder provided for this purpose in a folding box. Once the nest is completely empty, the handling device of the main module can place the product gripper back into the holder and pick up the tub-nest gripper. The sub-module can then fold back the second output area section. The sub-module can then return the empty tub to the second output area section if it has not remained there. The handling device of the main module can grab the empty nest and insert it into the provided tub. The sub-module can then remove the tub with the empty nest from the output area.

Overall, the system described above avoids the risk of human error, as the individual elements interact fully automatically. Furthermore, a high degree of flexibility is provided due to the simple adaptability to changed products by adapting the product changer. In addition, installation space is used efficiently and at the same time a high functional density and functional complexity are provided. According to a further aspect of the present disclosure, a use of the above devices in the handling of pharmaceutical products is provided.

Individual features and embodiments can be combined with each other to form new embodiments. Embodiments and advantages that are mentioned in connection with the features or with the embodiments then also apply analogously to the new embodiments. Embodiments and effects mentioned in connection with the device also apply analogously to the method and vice versa.

### BRIEF DESCRIPTION OF THE DRAWINGS

In the following, preferred embodiments are described in detail with reference to the attached figures.

FIG. 1 is a schematic and perspective view of an interface according to an embodiment of the present disclosure;

FIG. 2 is a schematic and perspective view of an interface according to an embodiment of the present disclosure;

FIG. 3 is a schematic and perspective view of a main module according to an embodiment of the present disclosure;

FIGS. 4A-4C are schematic and perspective views of a main module according to an embodiment of the present disclosure;

FIG. 5 is a schematic and perspective view of a sub-module according to an embodiment of the present disclosure;

FIG. 6 is a schematic and perspective view of a sub-module according to an embodiment of the present disclosure;

FIG. 7 is a schematic and perspective view of a sub-module according to an embodiment of the present disclosure;

FIG. 8 is a schematic top view of an arrangement of a handling system according to an embodiment of the present disclosure;

FIG. 9 is a schematic and perspective view of a handling system according to an embodiment of the present disclosure;

FIG. 10 is a schematic front view of a handling system according to an embodiment of the present disclosure;

FIG. 11 is a schematic sectional view of a handling system according to an embodiment of the present disclosure;

FIG. 12 is a schematic top view of a handling system according to the present disclosure;

FIGS. 13A, 13B are schematic perspective views of a part of a sub-module according to an embodiment of the present disclosure;

FIG. 14 is a schematic and perspective view of a part of a sub-module according to an embodiment of the present disclosure; and

FIG. 15 is a schematic flowchart of a method according to an embodiment of the present disclosure.

### DETAILED DESCRIPTION OF THE PREFERRED EMBODIMENTS

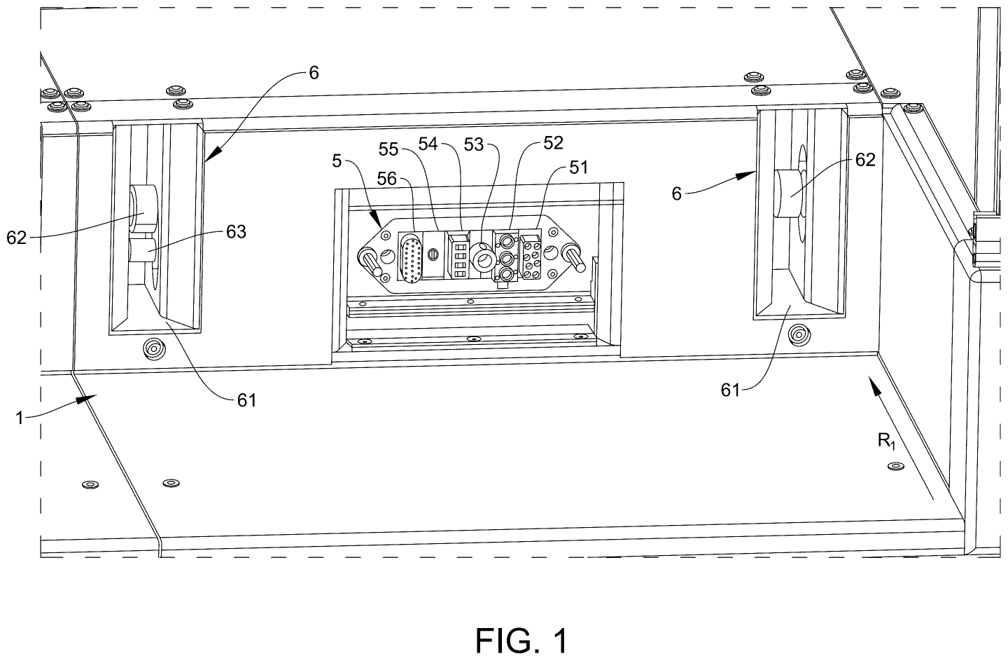

FIG. 1 is a schematic perspective view of an interface 1 of a main module 2 according to an embodiment of the present disclosure. The interface 1 shown in FIG. 1 is provided on the main module 2 for connecting a sub-module 3 (not shown in FIG. 1) to the main module 2. The interface 1 comprises a transfer contact 5 and a positioning element 6. The transfer contact comprises a first sub-contact 51 for a voltage supply by means of direct current and high voltage. Furthermore, the transfer contact 5 comprises a second sub-contact 52 for safety air compressed air, continuous air and main supply vacuum. Furthermore, the transfer contact 5 comprises a third sub-contact 53 for a protective circuit (potential equalization). The transfer contact 5 also comprises a fourth sub-contact 54 with an Internet connection (Ethernet connection). Furthermore, the transfer contact 5 comprises a fifth sub-contact 55 for a dummy cover, placeholder for later retrofitting of an electronic identification. Finally, the transfer contact 5 comprises a sixth sub-contact for an emergency stop signal (e.g. safety circuits of the safety doors as well as the emergency stop signal). The positioning element of the present embodiment comprises a recess 61 that extends in the contact direction R1. In the embodiment shown in FIG. 1, two positioning elements 6 are shown. Both positioning elements have an identical design. Furthermore, the positioning element 6 comprises a retaining element 62. The retaining element can be at least partially embraced by a complementary element. In addition, the positioning element 6 has a locking mechanism 63 that can lock a complementary positioning element. The locking mechanism 63 can be displaced between two positions in a direction transverse to the contact direction R1. In particular, the locking mechanism 63 can be designed to tighten a complementary positioning element in a force-locking manner in the contact direction R1.

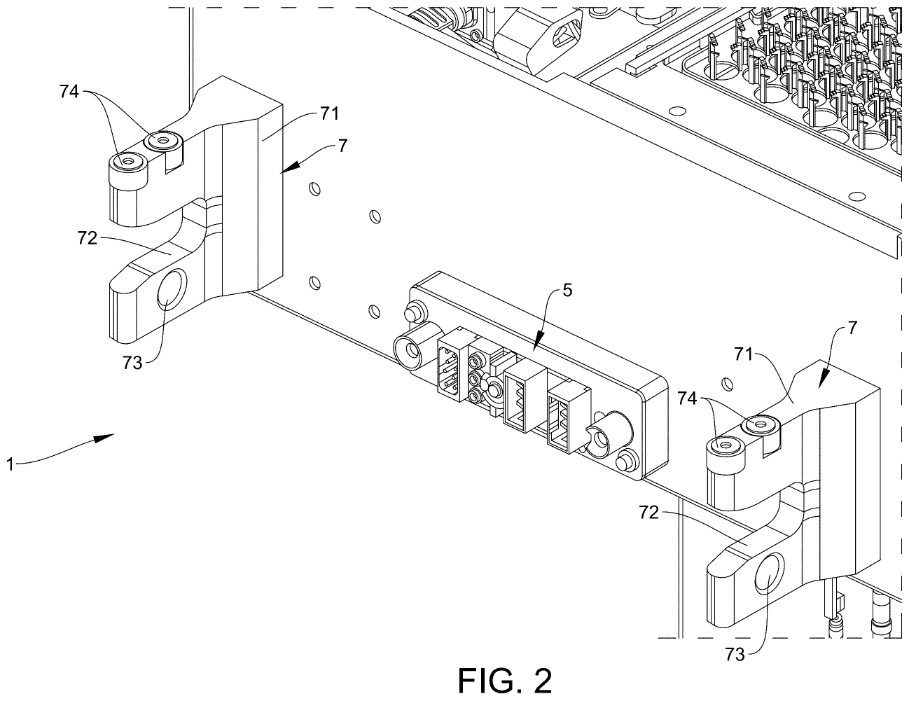

FIG. 2 is a schematic view of an interface 10 of a sub-module 3 for connecting the sub-module 3 to a main module 2. The interface 10 of the sub-module is complementary to the interface 1 of the main module 2, which is shown in FIG. 1. The interface 10 of the sub-module 3 also comprises a transfer contact 5 for providing communication between the main module 2 and the sub-module 3. Furthermore, the interface 10 of the sub-module 3 comprises at least one second positioning element 7, which is designed to interact with the first positioning element 6. The second positioning element 7 has a projection 71. In the embodiment shown in FIG. 2, two positioning elements are provided. The two positioning elements 7 have an identical design. The second positioning element 7 has a recess 72. Furthermore, the projection 71 has a through-hole 73, which can interact with the locking mechanism 63 of the interface 1 of the main module. Furthermore, the second positioning element of the present embodiment has two sliding elements 74, which are designed as rollers. The interface 1 of the main module 2 and the interface 10 of the sub-module 3 are complementary to each other. If an element of one interface and the other interface is assigned the same reference sign, this means that the elements are complementary in such a way that the interface 1 of the main module can interact with the interface 10 of the sub-module in such a way that information and/or media can be transmitted.

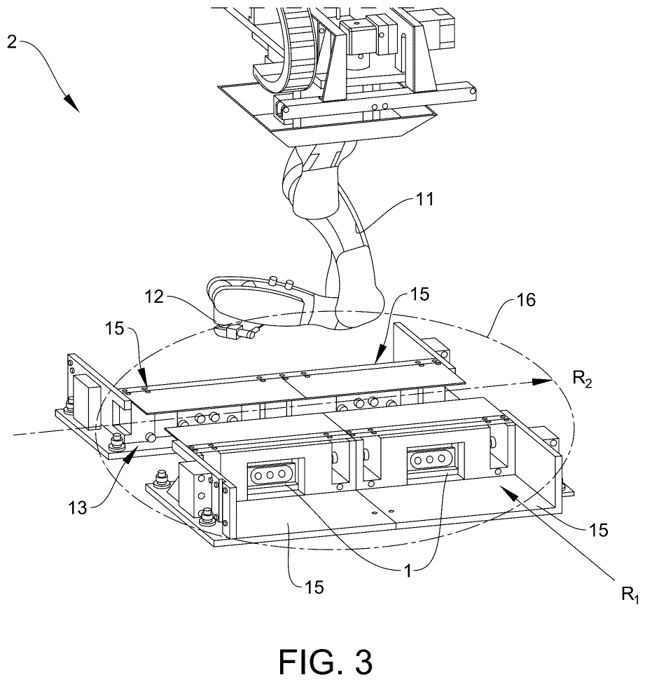

FIG. 3 is a schematic and perspective view of a main module 2 according to an embodiment of the present disclosure. The main module has at least one interface 1 according to one of the above embodiments. In the embodiment shown in FIG. 3, the main module 2 has four interfaces 1 according to one of the above embodiments. Two interfaces are arranged towards the image plane and two interfaces are arranged opposite each other in the image plane. The main module 2 of the present embodiment also has a handling device 11 in the form of a robot arm. The handling device 11 has an end effector connection 12 at its outer end. Many different end effectors can be arranged at the end effector connection. Furthermore, the main module 2 has a conveyor device 13, which is designed to convey pharmaceutical products and/or a package in a conveying direction R2. The conveying direction R2 is orthogonal to the contact direction R1. Furthermore, the main module 2 has a control unit 14 not shown in FIG. 3. The handling device 11 has a radius of action within which the handling device 11 can operate. Furthermore, the handling device of the present embodiment has four docking areas 15. An interface 1 is arranged in each docking area. Each docking area is therefore designed to accommodate a sub-module 3. The handling area 16 extends over the docking areas 15. In the present embodiment, the handling device 11 is designed as a six-axis robot. Furthermore, it can be seen that the handling device 11 is arranged at a central position above the conveyor device 13 in the main module 2.

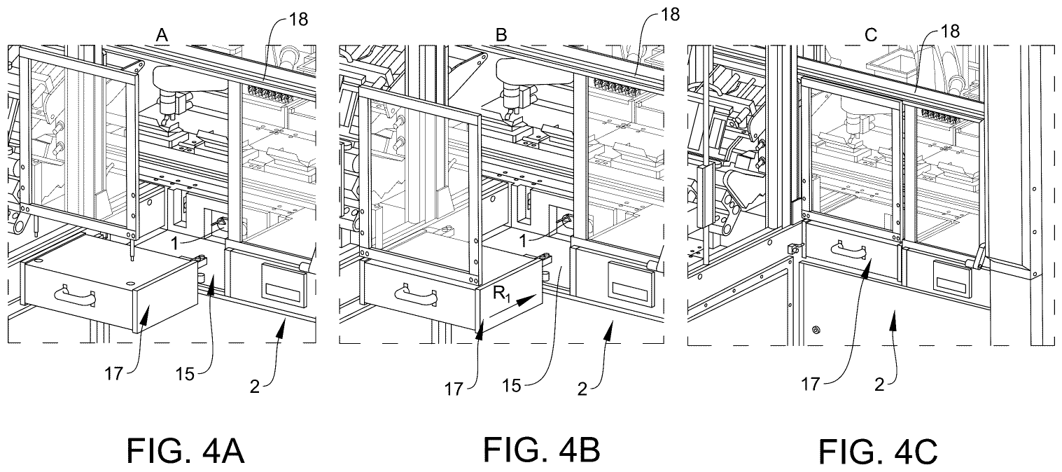

FIGS. 4A to 4C are schematic views of a part of a main module 2. In each of FIGS. 4A to 4C, a docking area 15 of a main module 2 can be seen. No sub-module 3 is arranged in the docking area 15. Furthermore, a protective device 18 can be seen, which surrounds the working area of the main module. An interruption in the protective device 18 can be seen in the docking area 15. This is due to the fact that a sub-module 3 can be arranged in the docking area 15. However, if no sub-module is required, a dummy cover 17 can be arranged in the docking area 15. The dummy cover 17 can have a complementary interface to the interface 1 of the main module. In FIG. 4A it can be seen that the dummy cover 17 consists of a part of a protective device and a case-like element. The part of the protective devices can be inserted into the case-like part. Then, as can be seen in FIG. 4B, the dummy cover can be inserted into the docking area 15. The dummy cover is inserted in the contact direction R1. FIG. 4C then shows how the dummy cover is arranged in the docking area, where it covers the interface 1 in particular. Furthermore, the protective device of the dummy cover also closes with the protective devices 18 of the main module 2 in order to protect the interior of the main module 2. Furthermore, the protective device can also protect an operator from the handling device 11.

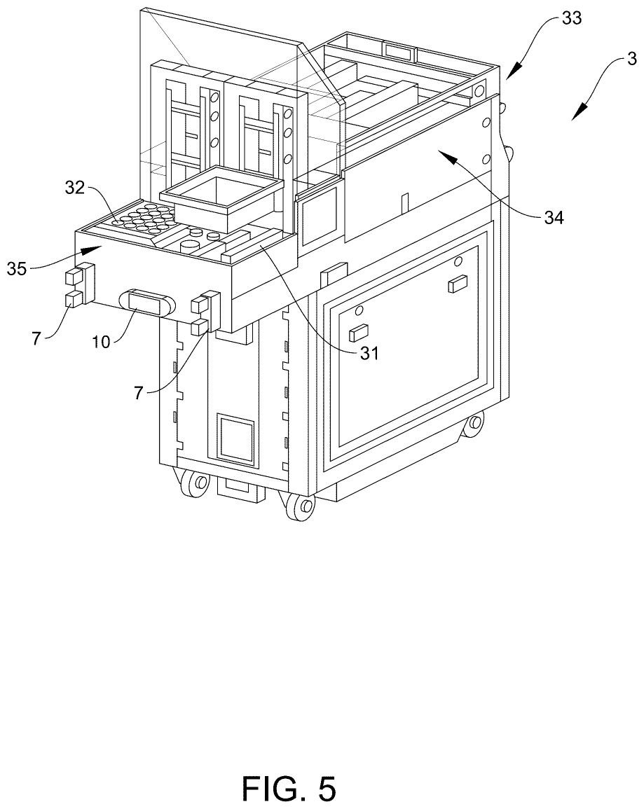

FIG. 5 is a schematic view of a sub-module 3 according to an embodiment of the present disclosure. The sub-module 3 is designed to be docked to a main module 2. The sub-module 3 comprises an interface 10 with the features of one of the above embodiments. Furthermore, the sub-module has an input area 33 to which pharmaceutical products can be input into the sub-module. Furthermore, the sub-module has a handling section 34 which, in the present embodiment, further transports the pharmaceutical products. The sub-module then has an output area 35, which is divided into a first output area section 31 and a second output area section 32. The output area 35 is, when the sub-module is connected to a main module 2, within the movement range of the handling device.

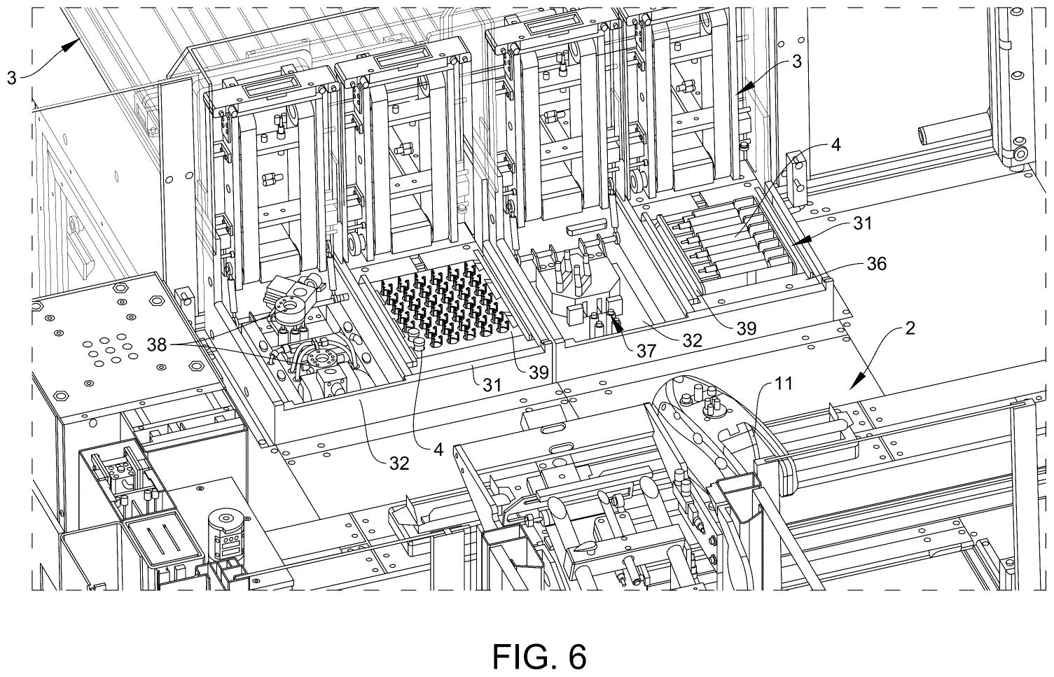

FIG. 6 is a schematic and perspective view of part of a sub-module 3 and a main module 2. In the embodiment shown in FIG. 6, two sub-modules are docked to a main module 2. It can also be seen that the conveyor belts of the first output area section 31 and the second output area section 32 are folded away. This allows the units underneath to be recognized. In the present embodiment, a nest holding device 36 is arranged under the transport device of the first output area section 31. An end effector holder is provided under the transport device of the second output area section 32. In the sub-module shown on the left-hand side in FIG. 6, it can be seen that two end effectors 38 are accommodated there. The nest holding device 36 arranged in the first output area section 31 can be designed to hold a nest that has been lifted out of a tub. In the position shown in FIG. 6, the handling device 11 of the main module 2 can begin to remove the pharmaceutical products 4 from the nests 39. On the right-hand side in FIG. 6, it can be seen that a plurality of pharmaceutical products 4 are arranged side by side in this nest 39. In the nest 39 shown on the left-hand side, it can be seen that a plurality of pharmaceutical products are arranged in a hanging position.

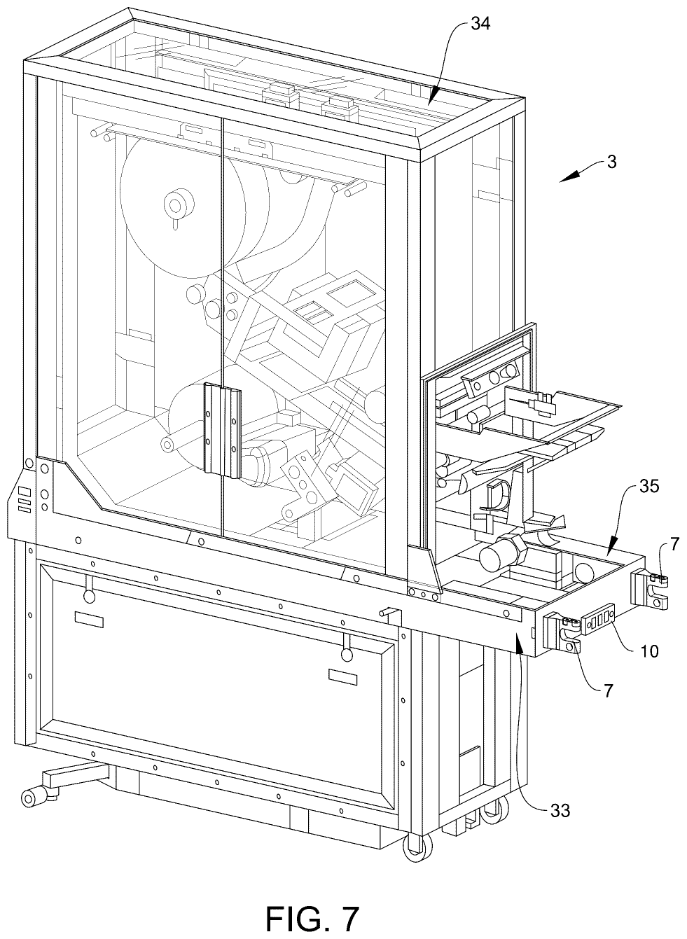

FIG. 7 is a schematic and perspective view of a sub-module 3 according to an embodiment of the present disclosure. The sub-module shown in FIG. 7 is a so-called service module, which can be connected to the main module in order to provide additional functionality. In contrast to the sub-module shown in FIG. 5, which is designed as a feed module, the sub-module shown in FIG. 7 can provide additional functionality for pharmaceutical products handled by the main module 2. The embodiment shown in FIG. 7 is a label printer. This allows a pharmaceutical product to be transferred by the handling device 11 of the main module 2 to an input area 33 of the sub-module 3. A label is then generated in a handling area 34 and applied to the pharmaceutical product, after which the finished pharmaceutical product is made available again at the output area 35. It can then be picked up from there by the handling device 11 of the main module. In the sub-module shown in FIG. 7, the input area 33 and the output area 35 are therefore provided on the same side. Furthermore, both areas are served by the handling device 11 of the main module.

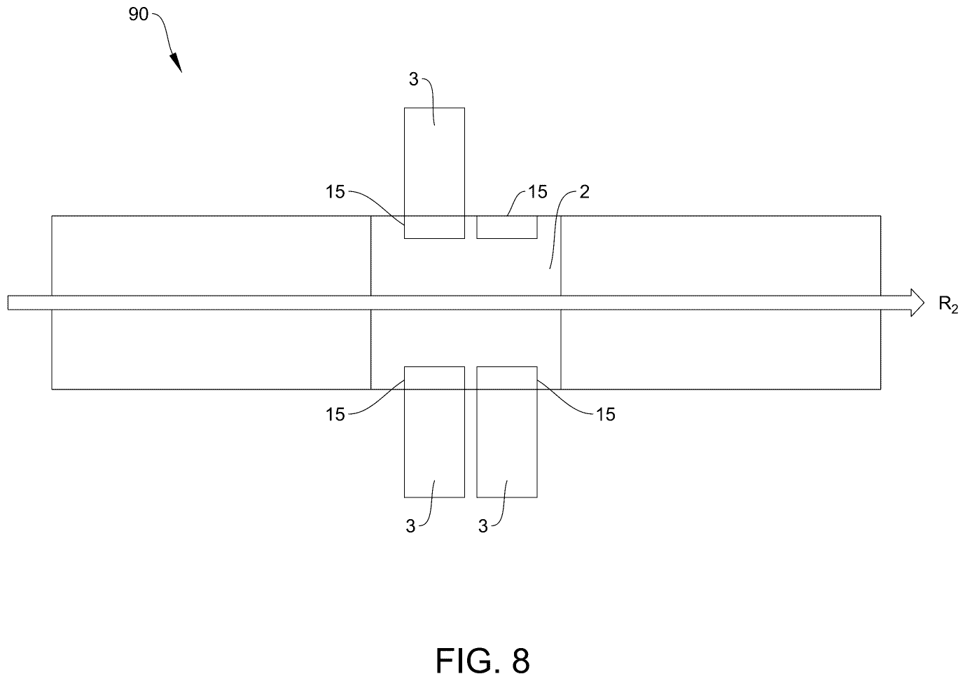

FIG. 8 is a schematic top view of a handling system 90 according to an embodiment of the present disclosure. This schematic illustration is intended to help better understand one of the core ideas of the present disclosure. In FIG. 8, a main module 2 with four docking areas 15 is shown schematically. A sub-module 3 is arranged at each of three of the four docking areas 15. The conveying direction R2 runs from left to right in FIG. 8. The conveying direction here also corresponds to the material flow. No sub-module 3 is arranged at the docking area 15 shown at the top right. For example, the blind cover described above can be provided here. This modular design allows functionality to be provided as required individually. Furthermore, changes in the type, size or kind of the pharmaceutical product can also be easily implemented.

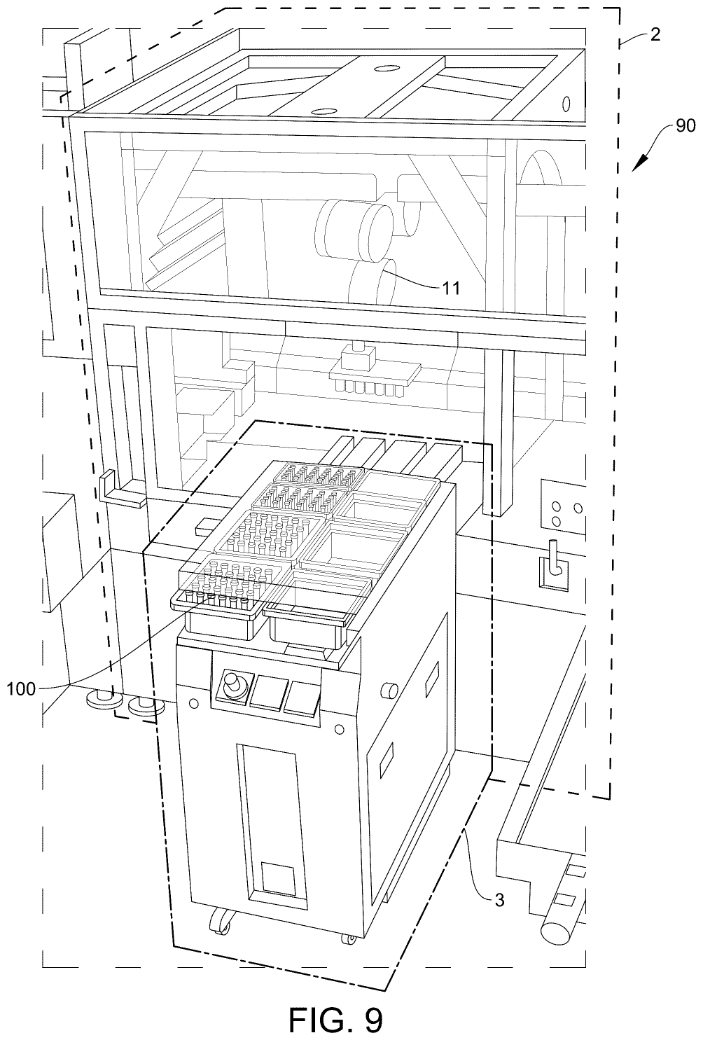

FIG. 9 is a schematic and perspective view of a handling system according to an embodiment of the present disclosure. It can be seen that only a sub-module 3 is connected to the main module 2. In the present embodiment, the sub-module 3 is for feeding pharmaceutical products to the main module 2. The handling device 11, which handles the pharmaceutical products 4, can be seen in the main module.

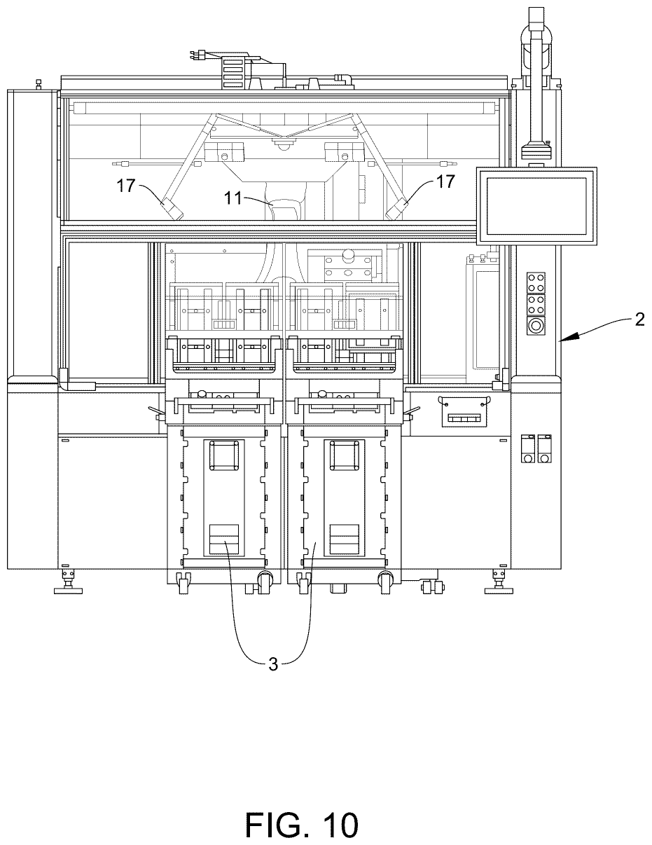

FIG. 10 is a schematic side view of a handling system 90 according to an embodiment of the present disclosure. A main module 2 can be seen, to which two sub-modules 3 are docked. Furthermore, the handling device 11 is recognizable in the main module 2, as it is arranged from above in the main module. In addition, a sensor system 17 is provided in the present embodiment. The sensor system 17 comprises at least one camera that monitors the handling area 16 of the handling device 11. Furthermore, the sub-module 3 can also be monitored by the sensor system 17. In particular, the output area 35 of the sub-module 3. In this way, for example, a type, kind or orientation of a pharmaceutical product can be recognized and the handling device 11 can be controlled accordingly.

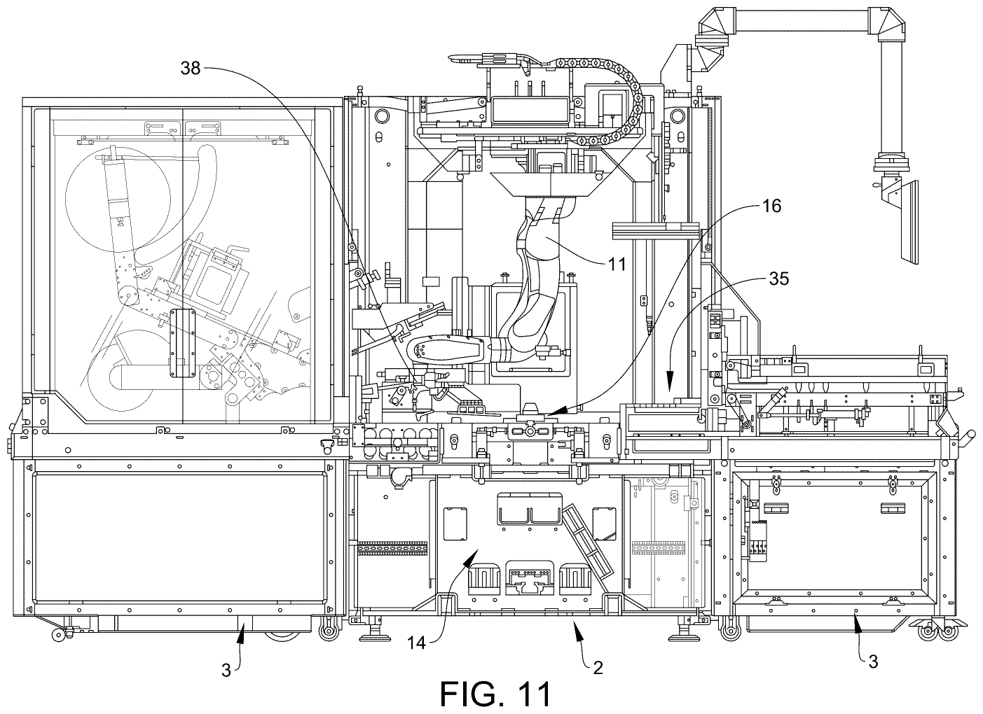

FIG. 11 is a schematic sectional view of a handling system 90 according to an embodiment of the present disclosure. It can be seen that a sub-module 3 is arranged on each of two opposite sides of the main module 2. The sub-module provided on the left-hand side is designed as a service module, which serves as a labeling device. The sub-module 3 arranged on the right-hand side is used to feed pharmaceutical products. The handling device 11 of the main module 2 in the center has an end effector 38 mounted on the handling device 11. Furthermore, the conveyor device can be seen in the center, which transports opened packages for pharmaceutical products in the transport direction, which runs into the image plane.

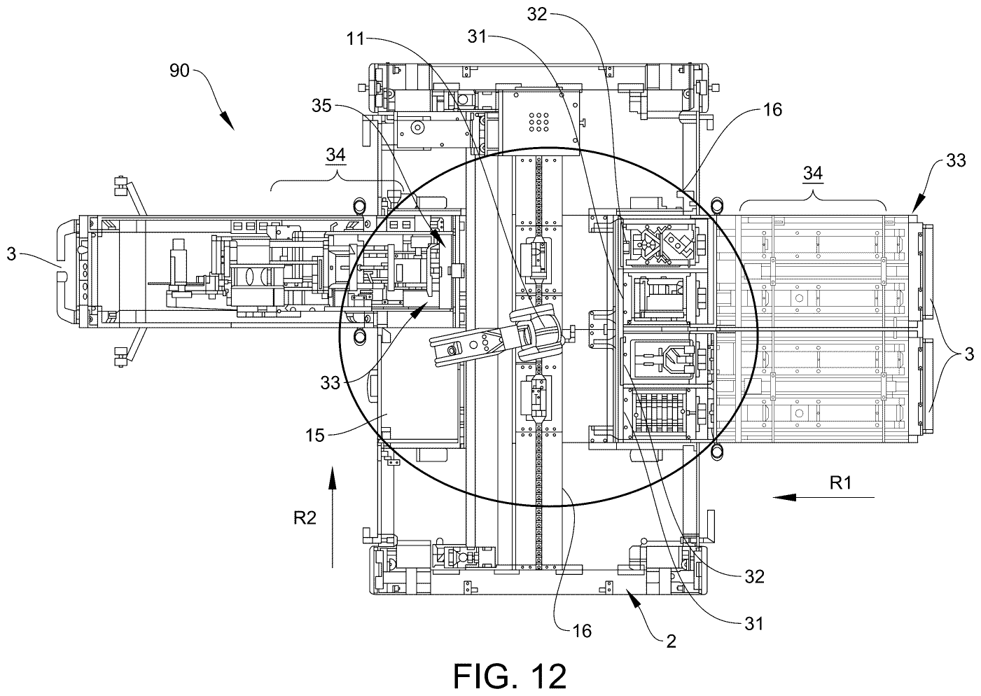

FIG. 12 is a schematic top view of a handling system 90 according to an embodiment of the present disclosure. As already shown in FIG. 8, the main module 2 also has three sub-modules 3 docked to it in the present embodiment. Two feed modules are shown on the right-hand side in FIG. 12. A service module is shown on the left-hand side. The service module 3 arranged on the left-hand side is designed to apply a label to the pharmaceutical products 4. The two modules shown on the right-hand side are designed as feed modules. The handling device 11 of the main module 2 can be seen in the center. Furthermore, the handling area 16 of the handling device 11 is shown by the circle. It can be seen that all four docking areas 15 are located in the handling area 16. One docking area 15 is not occupied by a sub-module, but by a dummy cover.

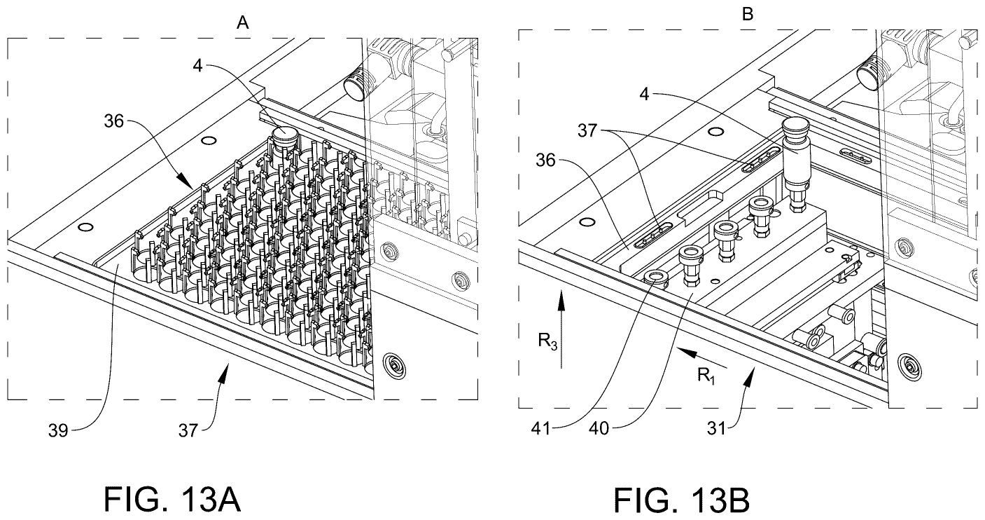

FIGS. 13A to 13B are detailed views of a first output area section 31 of a sub-module 3. FIG. 13A shows a nest 39 in the nest receiving device 36. It can also be seen that the pharmaceutical product, which in the present case is a vial, is held in the nest 36 by a clip mechanism. In other words, the clip force of the nest must first be overcome in order to pull the pharmaceutical product 4 out of the nest 39. In FIG. 13B, as in FIG. 13A, the first output area section 31 is shown only without the nest. The pharmaceutical product 4 is shown in the same position as in FIG. 13A. In FIG. 13B it can be seen that a cross table 40 is provided under the nest. The cross table can be moved along the first direction R1 and/or a transverse direction Rq. Furthermore, the cross table 40 has a plurality of plungers 41 which can be moved back and forth in a gravity direction R3. In other words, a plunger can contact a pharmaceutical product 4 from below and displace it in the direction R3. As a result, the pharmaceutical product 4 can be pushed out of the holder of the nest 39 so that the handling device 11 of the main module 2 can easily grip the pharmaceutical product 4.

Furthermore, the nest holding device 36 can be seen in FIG. 13B. The nest holding device 36 can hold a nest by means of vacuum suction cups 37. The vacuum suction cups are arranged in a row at intervals on a holding element, which can interact with the collar of a nest 36. This can prevent displacement of the nest 36, even if a plunger presses against a pharmaceutical product 4 from below or the handling device 11 pulls on the pharmaceutical product from above.

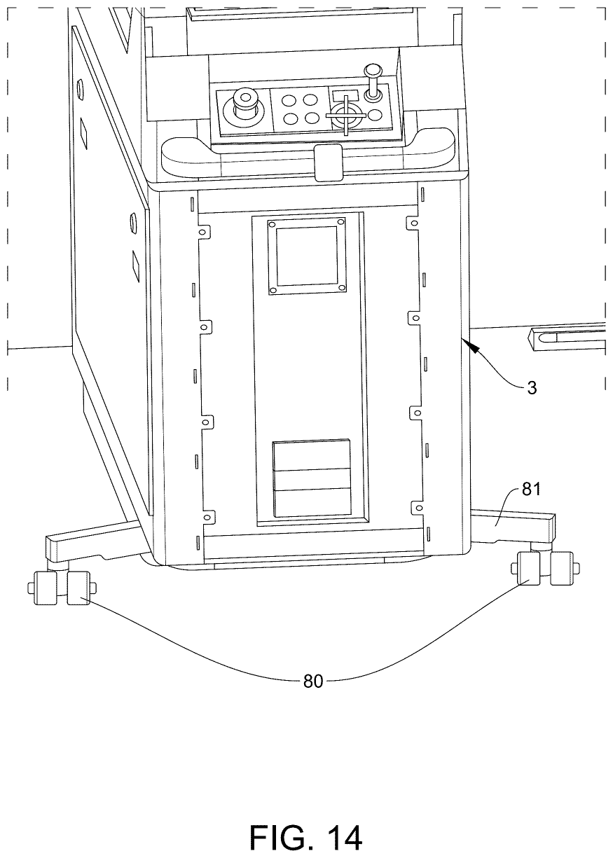

FIG. 14 is a schematic and perspective view of a part of a sub-module 3 according to an embodiment of the present disclosure. The sub-module shown in FIG. 14 essentially corresponds to the sub-modules described above. In the present sub-module, wheels are provided to displace the sub-module 3. Furthermore, the wheels are arranged on a frame 81. The frame can be folded in and out. As a result, the distance between the wheels 80 can be increased by an unfolding frame, whereby the sub-module achieves a firmer stand and is less susceptible to tipping. Furthermore, the sub-module of the present embodiment can have a traction drive that can drive the wheels 80. However, the drive can only be operated when the frame 81 is retracted.

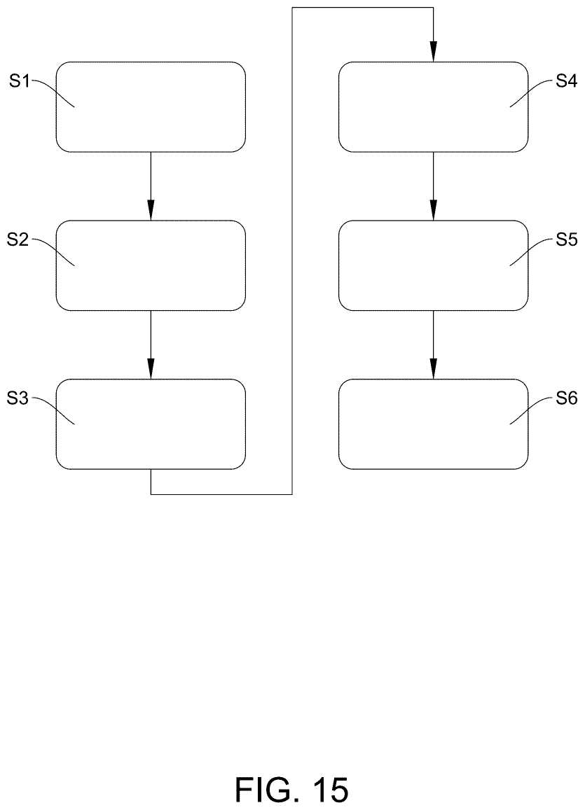

FIG. 15 is a schematic flowchart of a method according to one embodiment of the present disclosure. In step S1, a sub-module 3 is docked to a main module 2. In step S2, information is exchanged between the sub-module and the main module. In particular, the sub-module is registered with the main module or its control unit. In step S3, a tub with a nest and pharmaceutical products is moved into the sub-module. In step S4, an end effector 38 is provided for the handling device 11 in the sub-module 3. In step S5, a pharmaceutical product is transferred from a sub-module by the handling device 11 of the main module. In step S6, the transferred pharmaceutical product is fed to a package, which is transported by the conveyor device of the main module 2. Before the pharmaceutical product is fed to a package, it can optionally be fed to a service module (sub-module 3) for further processing of the pharmaceutical product, such as the application of a label. Alternatively, the pharmaceutical product can also be fed directly into packaging.

### LIST OF REFERENCE SIGNS

1 Interface of the main module
2 Main module
3 Sub-module
4 Pharmaceutical products
5 Transfer contact
6 First positioning element
7 Second positioning element
10 Interface of the sub-module
11 Handling device
12 End effector connection
13 Conveyor device
14 Control unit
15 Docking area
16 Handling area
17 Dummy cover
18 Protective device
51 First sub-contact
52 Second sub-contact
53 Third sub-contact
54 Fourth sub-contact
55 Fifth sub-contact
56 Sixth sub-contact
61 Recess
62 Retaining element
63 Locking mechanism
71 Projection
72 Recess
73 Through-hole
74 Sliding element
31 First output area section
32 Second output area section
33 Input area
34 Handling section
35 Output area
36 Nest holding device
38 End effector
39 Nest
90 Handling system
17 Sensor system
40 Cross table
41 Plunger
37 Vacuum connections
80 Wheels
81 Frame
R1 Contact direction
R2 Conveying direction
R3 Gravity direction
Rq Transverse direction

1. A main module for handling pharmaceutical products, comprising:
at least one interface for connecting a sub-module to the main module, wherein the sub-module and the main module in a connection position are configured to handle pharmaceutical products, wherein the at least one interface comprises:
at least one transfer contact for providing communication between the main module and the sub-module when the sub-module and the main module are in the connection position; and
at least one first positioning element, configured to cooperate with a second positioning element of the sub-module to guide the sub-module and the main module into the connection position;
a handling device configured to handle pharmaceutical products in a handling area;
a control unit for controlling the handling device; and
a conveyor device configured to convey pharmaceutical products in a conveying direction.

2. The main module according to claim 1, wherein the main module further comprises:
at least one docking area with the at least one interface, wherein the docking area and the handling area at least partially overlap.

3. The main module according to claim 2, wherein the control unit is configured to additionally control at least one sub-module docked to the interface.

4. The main module according to claim 3, wherein the handling device comprises an end effector connection configured to connect a plurality of different end effectors.

5. The main module according to claim 4, wherein the at least one interface includes more than two interfaces, so that more than two sub-modules can be connected to the main module.

6. A sub-module for connection to a main module for handling pharmaceutical products, comprising:
an interface for connecting the sub-module to a main module, wherein the sub-module and the main module are configured in a connection position to handle pharmaceutical products, wherein the interface comprises:
at least one transfer contact for providing communication between the main module and the sub-module when the sub-module and the main module are in the connection position; and
at least one second positioning element, configured to cooperate with a first positioning element of the main module to guide the sub-module and the main module into the connection position;
an input area configured to receive pharmaceutical products;
a handling section configured to handle the pharmaceutical products; and
an output area configured to provide the pharmaceutical products;
wherein the output area can be arranged in a docking area of the main module.

7. The sub-module according to claim 6, wherein the sub-module further comprises:
an end effector holder for receiving at least one end effector for a handling device of the main module.

8. The sub-module according to claim 7;
wherein the output area is configured to at least partially release pharmaceutical products from a holder in the nest; and/or
wherein the output area has a first output area section and a second output area section, wherein the first output area section is optionally configured to transport a tub with a nest using a first conveyor device.

9. The sub-module according to claim 8, wherein the sub-module further comprises:
a memory configured to store product information and/or information about the sub-module, wherein the sub-module is configured to output the product information and/or information about the sub-module via the interface.

10. A handling system for handling pharmaceutical products, comprising:
at least one interface for connecting a sub-module to the main module, wherein the sub-module and the main module in a connection position are configured to handle pharmaceutical products, wherein the at least one interface comprises:
at least one transfer contact for providing communication between the main module and the sub-module when the sub-module and the main module are in the connection position; and
at least one first positioning element, configured to cooperate with a second positioning element of the sub-module to guide the sub-module and the main module into the connection position;
a handling device configured to handle pharmaceutical products in a handling area;
a control unit for controlling the handling device; and
a conveyor device configured to convey pharmaceutical products in a conveying direction; and
a sub-module for connection to a main module for handling pharmaceutical products, comprising:
an interface for connecting the sub-module to a main module, wherein the sub-module and the main module are configured in a connection position to handle pharmaceutical products, wherein the interface of the sub-module comprises:
at least one transfer contact for providing communication between the main module and the sub-module when the sub-module and the main module are in the connection position; and
at least one second positioning element, configured to cooperate with the first positioning element of the main module to guide the sub-module and the main module into the connection position;
an input area configured to receive pharmaceutical products;
a handling section configured to handle the pharmaceutical products; and
an output area configured to provide the pharmaceutical products;
wherein the output area can be arranged in a docking area of the main module.

11. The handling system according to claim 10, wherein the main module and/or the at least one sub-module has or have a measuring device configured to determine a position of the at least one sub-module relative to the main module.

12. The handling system according to claim 10, wherein the control unit of the main module is configured to obtain product information about the pharmaceutical product to be handled via the interfaces; and/or
wherein the control unit of the main module is configured to obtain functional information of the sub-module via the interfaces.

13. The handling system according to claim 10, wherein the handling device is configured to pick up a pharmaceutical product from a first sub-module and transfer it to a second sub-module.

14. The handling system according to claim 10, wherein the handling device is configured to handle a tub with a nest in an output area of the sub-module.

15. The method of handling pharmaceutical products comprising:
picking up a pharmaceutical product from a sub-module by a handling device of a main module; and
introducing the pharmaceutical product into a package transported by a conveyor device of the main module.

16. The main module according to claim 1, wherein the control unit is configured to additionally control at least one sub-module docked to the interface.

17. The main module according to claim 1, wherein the handling device comprises an end effector connection configured to connect a plurality of different end effectors.

18. The main module according to claim 1, wherein the at least one interface includes more than two interfaces, so that more than two sub-modules can be connected to the main module.

19. The sub-module according to claim 6;
wherein the output area is configured to at least partially release pharmaceutical products from a holder in the nest; and/or
wherein the output area has a first output area section and a second output area section, wherein the first output area section is optionally configured to transport a tub with a nest using a first conveyor device.

20. The sub-module according to claim 6, wherein the sub-module further comprises:
a memory configured to store product information and/or information about the sub-module, wherein the sub-module is configured to output the product information and/or information about the sub-module via the interface.
